(19) United States
(12) Patent Application Publication
(10) Pub. No.: US 2019/0080427 A1
(43) Pub. Date: Mar. 14, 2019

(54) SOCIAL INTERACTION APPLICATION AND SYSTEM

(71) Applicant: JGL Enterprises LLC, Milwaukee, WI (US)

(72) Inventor: Jeff Lippert, Milwaukee, WI (US)

(73) Assignee: JGL Enterprises LLC, Milwaukee, WI (US)

(21) Appl. No.: 16/084,878

(22) PCT Filed: Mar. 15, 2017
(86) PCT No.: PCT/US2017/022550

§ 371 Date: Sep. 13, 2018

Related U.S. Application Data
(60) Provisional application No. 62/309,265, filed on Mar. 16, 2016.

(51) Int. Cl. G06Q 50/34; G06Q 50/00; G07F 17/32

(52) U.S. Cl. CPC G06Q 50/34; G07F 17/323; G06Q 50/01

(57) ABSTRACT

A social betting system includes a computing device configured to receive, via an application on a first device, a proposed wager and one or more parameters of the wager. The computing device determines conformance of the proposed wager and parameters, and transmits, to the application on a second device, the wager and the parameters. The computing device receives, via the second device, a response to the wager and the parameters and finalizes the wager and the one or more parameters of the wager. The computing device determines an outcome of the wager and transmits, to the application on the first device and second device, a resolution of the wager.

### CROSS-REFERENCE TO RELATED APPLICATION

This application claims the benefit of and priority to U.S. Application No. 62/309,265, filed Mar. 16, 2016, which is hereby incorporated by reference herein in its entirety.

### BACKGROUND

The present disclosure relates generally to mobile applications. According to some exemplary embodiments, the present disclosure relates more particularly to systems and methods for providing a social betting mobile application.

Individuals often make social wagers with one another. For example, two friends may wager lunch after a round of golf for whomever has a lowest score. Typically, such wagers are agreed upon orally, such as in person. Messaging applications may be used on electronic devices to informally propose such wagers, but such applications do not keep track of the wagers or perform any other functions with respect to the wagers.

### SUMMARY

One embodiment of the present disclosure relates to a system including at least one computing device operably coupled to at least one memory. The at least one computing device is configured to receive, from an application on a first device, a first set of data packets indicating a proposed wager and one or more parameters of the wager. The at least one computing device is further configured to process, using a rules engine, the first set of data packets to determine conformance of the proposed wager and the one or more parameters of the wager to a set of predetermined rules. The at least one computing device is further configured to, in response to determining the proposed wager and the one or more parameters conform to the rules, transmit, to the application on a second device, a second set of data packets indicating the proposed wager and the one or more parameters of the wager. The at least one computing device is further configured to receive, from the second device, a third set of data packets indicating a response to the proposed wager and the one or more parameters of the wager. The at least one computing device is further configured to finalize the wager and the one or more parameters of the wager in response to determining the response indicates an approval. The at least one computing device is further configured to determine an outcome of the wager. The at least one computing device is further configured to transmit, to the application on the first device and the second device, a fourth set of data packets indicating a resolution of the wager.

In some embodiments, the at least one computing device is configured to generate a list of pre-approved wagers and one or more parameters for each wager and transmit, to the first device, the list of pre-approved wagers and one or more parameters for each wager. Receiving the first set of data packets includes receiving a selection of a pre-approved wager and one or more values representative of one or more parameters of the wager.

In some embodiments, the at least one computing device is configured to analyze the first set of data packets to determine the type of wager, determine whether the user has permission to participate in the type of wager, approve the wager in response to determining the user has permission, and set the one or more parameters for the wager.

In some embodiments, the at least one computing device is configured to analyze the first set of data packets to determine the wager relates to a contest hosted by a third party, access information from the third party, and determine at least one of the one or more parameters of the wager or the outcome of the wager from the accessed information. In some embodiments, accessing information from the third party includes receiving an additional set of data packets from the first device comprising information from the application relating to the contest.

In some embodiments, the wager is based on the outcome of a third party event. The at least one computing device is further configured to automatically determine the outcome of the wager using information about the third party event obtained from a source other than the first device and the second device.

In some embodiments, the wager is based on the outcome of an event occurring involving at least one of a first user of the first device and a second user of the second device. The at least one computing device is further configured to receive the outcome of the wager from one of the first device and second device.

In some embodiments, finalizing the wager and the one or more parameters of the wager includes receiving a modification of one or more parameters of the proposed wager from the second device, transmitting the modification of the one or more parameters of the proposed wager to the first device, receiving one of a modification of the one or more parameters of the proposed wager or an approval of the one or more parameters of the wager, and continuing to transmit modified parameters of the proposed wager to both the first device and second device, and receive a modification of the one or more parameters, until an approval of the one or more parameters of the wager is received from both the first device and second device.

In some embodiments, the one or more parameters of the wager include at least one of a date or time when the wager will occur; a duration of the wager; a deadline for the wager when the event associated with the wager is scheduled to end; one or more threshold values that indicates a winning event or losing event associated with the wager; a location of where the wager will occur; one or more user credentials of one or more users involved in the wager; and compensation to be provided to one or more users upon the completion of the wager.

In some embodiments, the at least one computing device is further configured to receive approval from the first device and second device to allow the wager to be presented within a social media interface within the application on other devices. The other devices are associated with users connected to a user of at least one of the first device or the second device through the application. The social media interface is configured to display a status of the wager and the one or more parameters of the wager.

Another embodiment of the present disclosure relates to a method. The method includes receiving, at a server from an application on a first device, a first set of data packets indicating a proposed wager and one or more parameters of the wager. The method further includes processing, using a rules engine, the first set of data packets to determine conformance of the proposed wager and the one or more parameters of the wager to a set of predetermined rules. The method further includes in response to determining the proposed wager and the one or more parameters conform to the rules, transmitting, by the server to the application on a second device, a second set of data packets indicating the proposed wager and the one or more parameters of the wager. The method further includes receiving, at the server from the second device, a third set of data packets indicating a response to the proposed wager and the one or more parameters of the wager. The method further includes finalizing, at the server, the wager and the one or more parameters of the wager in response to determining the response indicates an approval. The method further includes determining, at the server, an outcome of the wager. The method further includes transmitting, by the server to the application on the first device and the second device, a fourth set of data packets indicating a resolution of the wager.

In some embodiments, the first set of data packets include information relating to at least one of a selection of a wager and one or more values representative of one or more parameters of the wager from a list of pre-approved wagers, an indication of if the wager is to be made private to the users involved in the wager, one or more user credentials to be verified at the server, and an identification of one or more participants in the wager.

In some embodiments, the method further includes analyzing the first set of data packets to determine the type of wager, determining whether the user has permission to participate in the type of wager, approving the wager in response to determining the user has permission, and setting the one or more parameters for the wager.

In some embodiments, finalizing the wager and the one or more parameters of the wager includes receiving a modification of one or more parameters of the proposed wager from the second device, transmitting the modification of the one or more parameters of the proposed wager to the first device, receiving one of a modification of the one or more parameters of the proposed wager or an approval of the one or more parameters of the wager, and continuing to transmit modified parameters of the proposed wager to both the first device and second device, and receive a modification of the one or more parameters, until an approval of the one or more parameters of the wager is received from both the first device and second device.

In some embodiments, the one or more parameters of the wager include at least one of a date or time when the wager will occur, a duration of the wager, a deadline for the wager when the event associated with the wager is scheduled to end, one or more threshold values that indicates a winning event or losing event associated with the wager, a location of where the wager will occur, one or more user credentials of one or more users involved in the wager, and compensation to be provided to one or more users upon the completion of the wager.

In some embodiments, the method further includes receiving approval from the first device and second device to allow the wager to be presented within a social media interface within the application on other devices. The other devices are associated with users connected to a user of at least one of the first device or the second device through the application. The social media interface is configured to display a status of the wager and the one or more parameters of the wager.

Another embodiment of the present disclosure relates to a social wagering system. The social wagering system includes a plurality of user devices, each user device including a social wagering application. The social wagering system further includes a server configured to manage a plurality of wagers of one or more users of the user devices, the server including a processor and a memory having instructions stored thereon. The instructions, when executed by the processor, cause the processor to receive a first set of data packets from a first device indicating a proposed wager and one or more parameters of the wager, and to determine conformance of the proposed wager and the one or more parameters of the wager to a set of predetermined rules. The instructions further cause the processor to transmit a second set of data packets indicating the proposed wager and the one or more parameters of the wager to a second user device, receive a third set of data packets indicating a response to the proposed wager and the one or more parameters of the wager, and finalize the wager. The instructions further cause the processor to determine an outcome of the wager and transmit a resolution of the wager to the application on the first device and second device.

In some embodiments, establishing the wager includes generating a list of pre-approved wagers and one or more parameters for each wager, transmitting, to the first device, the list of pre-approved wagers and one or more parameters for each wager, and receiving a selection of a pre-approved wager and one or more values representative of one or more parameters of the wager.

In some embodiments, establishing the wager includes analyzing the first set of data packets to determine the type of wager, determining whether the user of the first device has permission to participate in the type of wager, approving the wager in response to determining the user has permission, and setting the one or more parameters for the wager.

In some embodiments, finalizing the wager includes receiving a modification of one or more parameters of the proposed wager from the second user device, transmitting the modification of the one or more parameters of the proposed wager to the first user device, receiving one of a modification of the one or more parameters of the proposed wager or an approval of the one or more parameters of the wager, and continuing to transmit modified parameters of the proposed wager to both the first user device and second user device, and receive a modification of the one or more parameters, until an approval of the one or more parameters of the wager is received from both the first device and second device.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a block diagram of a social betting system and a plurality of users, according to an exemplary embodiment;

FIG. 2 is a detailed block diagram of the social betting system of FIG. 1, according to an exemplary embodiment;

FIG. 3 is an example user interface of the social betting system, according to an exemplary embodiment;

FIG. 4 is an example user interface for signing up or logging into the social betting system, according to an exemplary embodiment;

FIG. 5 is an example user interface of a main page or home page for the social betting system, according to an exemplary embodiment;

FIG. 6 is an example user interface creating a challenge or bet via the social betting system, according to an exemplary embodiment;

FIG. 7 is an example user interface for adding one or more friends or other users to a challenge or bet via the social betting system, according to an exemplary embodiment;

FIG. 8 is an example user interface for adding one or more friends or other users to a challenge or bet and assigning to the users to one or more teams via the social betting system, according to an exemplary embodiment;

FIG. 9 is an example user interface for reviewing and adjusting challenge or bet details via the social betting system, according to an exemplary embodiment;

FIG. 10 is an example user interface for reviewing and adjusting user account settings via the social betting system, according to an exemplary embodiment;

FIG. 11 is a flow chart of a process for creating a bet via the social betting system, according to an exemplary embodiment; and

FIG. 12 is a flow chart of a process for confirming a bet with one or more users via the social betting system, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, a social betting system implementable on a mobile device is described. The social betting system may generally allow multiple users to place and accept bets with one another, and may track the bets for the users. In some embodiments, the social betting system may control the types of bets and wagers that are allowed to be created and accepted by the users (i.e., providing a predetermined list of wagers or bets to one or more users). In some embodiments, the social betting system may include a payment system for handling payments between users when the winners and losers of the bet are determined. The social betting system may manage monetary bets or non-monetary bets.

In various embodiments, the system may be designed to implement rules that govern the behavior of the application, such as by restricting the types of wagers that can be made depending on a geographic region. For example, in some implementations, the system may determine a current geographic location of the device on which the application is executed. Based on the location, the device may restrict the types of wagers available through the application to a subset of all possible types of wagers the system allows. For example, in some implementations, the system may restrict the types of wagers available to only those wagers known or believed to be legal to make in the state/country/etc. in which the device is operated.

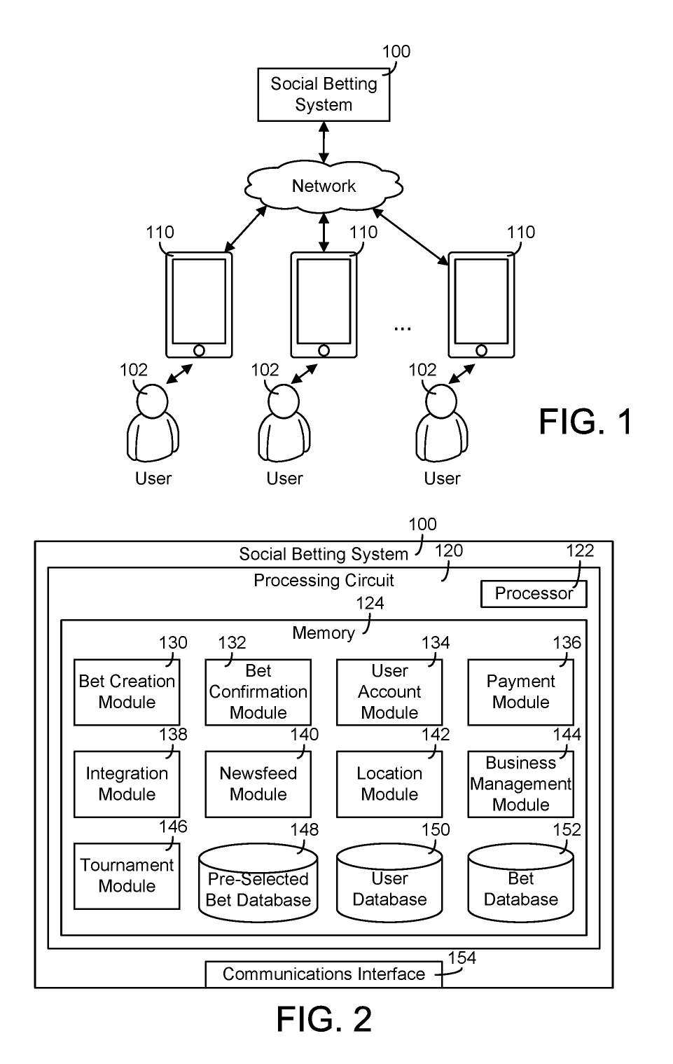

Referring now to FIG. 1, a block diagram illustrating an interaction between a social betting system 100 and a plurality of users 102 is shown. The social betting system 100 is shown in communication with a plurality of user devices 110 that can be used by the users to interact with the social betting system 100. The user devices 110 may display a social betting application, allowing users to interact with the social betting system 100. For example, a user may propose a bet to another user, accept a bet from another user, view the status of one or more bets, or otherwise interact with the social betting system 100 via the social betting application.

In some embodiments, users 102 may interact with the social betting system 100 via mobile devices, such as smartphones. In other embodiments, users 102 may interact with the social betting system 100 via any electronic device, such as a desktop computer, laptop, tablet, etc. While subsequent figures in the present disclosure describe the social betting application as displayed on a smartphone, it should be understood that in other embodiments, the social betting application may be presented on any type of electronic device. Further, the user devices may communicate with the social betting system 100 via any type of wired or wireless connection.

Referring now to FIG. 2, the activities of the social betting system 100 are shown in greater detail. The social betting system 100 receives and manages bets placed by users. For example, the social betting system 100 may receive a proposed bet from a first user and an acceptance (or refusal) of the bet by one or more second users. The social betting system 100 may alert the users to the status or result of the bet, and may optionally be used to track the status of the bet. The social betting system 100 may further provide bet information to a portion of the social betting system (e.g., a social betting application) on the user devices of the users, may facilitate payment or other bet resolutions between users, may manage one or more user accounts associated with the users making the bets, and provide any other betting-related feature.

In some embodiments, the social betting system 100 may be implementable at a central server configured to receive communications from a plurality of user devices. In some embodiments, the social betting system 100 may be implementable via cloud computing. In other embodiments, more than one server may implement various functionalities of the social betting system (i.e., different servers may execute different functionality of the system). It should be understood that the social betting system may be implementable in any type of computing environment without departing from the scope of the present disclosure. The social betting system includes a communications interface 154 for facilitating wired or wireless communication with the various user devices and between different servers.

The social betting system 100 is shown to include a processing circuit 120 including a processor 122 and a memory 124. The processor 122 may be implemented as a general purpose processor, an application specific integrated circuit (ASIC), one or more field programmable gate arrays (FPGAs), a group of processing components, or other suitable electronic processing components. The memory 124 is one or more devices (e.g., RAM, ROM, flash memory, hard disk storage, etc.) for storing data and/or computer code for completing and/or facilitating the various user or client processes, layers, and modules described in the present disclosure. The memory 124 may be or include volatile memory or non-volatile memory. The memory 124 may include database components, object code components, script components, or any other type of information structure for supporting the various activities and information structures of the present disclosure. The memory 124 is communicably connected to the processor 122 and includes computer code or instruction modules for executing one or more processes described herein.

The memory 124 is shown to include a bet creation module 130 configured to facilitate the creation of a bet by a user. A first user may access the social betting application and use the social betting application to create a bet between himself or herself and one or more other second users. The bet creation module 130 may retrieve and provide a list of bets and betting options to the user via the social betting application, and may provide one or more input forms to allow a user to enter one or more bet parameters.

In some embodiments, the bet creation module 130 provides a list of pre-selected bets to the user. For example, the bet creation module 130 may access a list of bets eligible for selection by the user, from a pre-selected bet database 148 or other data store. The list of pre-selected bets may include bets related to one or more events, such as a sporting event. For example, bets may include a bet on an outcome of a professional sporting event. As another example, bets may include a bet on an outcome of an event to be conducted between the users involved the bet (i.e., a round of golf, a tennis match, a bowling match, etc.). The list of pre-selected bets may be customized by the bet creation module 130 based on which bets are allowed to be presented to the user (i.e., only presenting bets that are permitted according to the rules established by the social betting system 100, such as only permitting bets in a particular location that are legal to be made via the social betting system 100). For example, betting on a sporting event may or may not be legal depending on the location of the users.

The list of pre-selected bets may be accessed by the user in various ways. For example, the user may be able to select from a list of bets via one or more menus on a user interface. As another example, the user may enter one or more parameters or another description of a type of bet the user wishes to view. The bet creation module 130 may then retrieve a subset of pre-selected bets that fit the parameters or description. In some embodiments, the user may enter the parameters via a text field. In some embodiments, the user may enter the parameters via a voice command, and the bet creation module 130 (or the social betting system 100 more generally) may be configured to interpret the voice command.

In some embodiments, the bet creation module 130 may allow a user to customize or partially customize a bet. For example, the bet creation module 130 may allow the user to create a bet and to set the parameters for the bet. As another example, the user may select a bet from the list of pre-determined bets, but may adjust one or more parameters of the bet (e.g., a handicap adjustment for a round of golf). Further, the user may be able to provide a customized message to other users the user wishes to challenge in the bet. For example, a user may create a video, or an audio clip, describing the bet and the parameters of the bet. As another example, the user may create a customized text message to send to other users. In some embodiments, the bet creation module 130 may be configured to receive an video, audio, or text file from the user and to determine the bet and parameters of the bet specified via the video, audio, or text. In some embodiments, the video, audio, or text file may simply accompany another input from the user specifying the bet and the parameters of the bet.

The bet creation module 130 may allow a user to adjust various parameters for the bet. For example, the user may set a time or duration of the bet (i.e., if the bet is to be conducted in an event between two or more users), set a time for the bet (i.e., the activity specified in the bet must be completed by a certain date or time or within a certain time window), set a deadline for the bet (i.e., a time by which the bet must be accepted or declined) and set a location of the bet (i.e., the location at which the activity will occur). If the bet selected by the user relates to an event not directly involving the user (i.e., a professional sporting event), then the bet creation module 130 may pre-determine one or more parameters of the bet (e.g., the time by which the bet must be accepted). In some embodiments, the parameters may include a handicap or odds. A handicap may be used to even a competition between two users or entities if one user or entity. is considered a favorite in the game or skill involved with the bet. For example, one user may be more skilled at a game (e.g., golf) than the other. As another example, if the users are betting on a sporting event, one team may be a favorite over the other team. The odds or handicap may be adjusted to ensure that the bet is competitive for all users involved. In some embodiments, one or more users may adjust the odds or handicap. For example, if one user is a favorite in a game of skill, that user could adjust the odds to entice a less skilled user to participate.

The bet creation module 130 may allow the user to specify if the bet is a public bet or a private bet. The user may specify whether the bet should be made private between the users participating in the bet (i.e., not making the bet accessible or viewable to other users) or if the bet can be made public (i.e., viewable to users not participating in the bet). The private or public designation of the bet may be used as described below to determine if and how to share the bet and bet results with other users (e.g., whether to share the bet in a newsfeed of the social betting application). In some embodiments, users involved with a private bet may still choose to make the bet viewable to other friends if they choose to.

The user may specify the one or more other users to participate in the bet to the bet creation module 130. In some embodiments, the user may select the other users from a list of contacts or list of users maintained either on the user device 110 or at the social betting system 100 (e.g., in a user database). For example, the social betting system 100 may provide a list of phone contacts on the mobile device of the user, a friends list on a social media site associated with an account of the user, a contact list on an email application of the mobile device, or otherwise. In another embodiment, the user may enter the user information of the other users manually (e.g., name and email or other contact information for contacting the user). In some implementations, the social betting system 100 may be configured to receive information from other applications to retrieve contacts. For example, the user may provide credentials for a social media site and provide input indicating permission to retrieve a friends or contact list from the social media site. In some embodiments, the friends may be current users of the social betting system 100, and the social betting system 100 may link the user with the friends and/or allow the user to connect with them within the context of the social betting application. In some embodiments, the friends may not be current users of the system, and the user may be invited to send invitations to join the social betting system 100 to the friends.

The bet creation module 130 may allow the user to specify the stakes of the bet. In one embodiment, the stakes of the bet may be monetary, and the user may choose an amount or select from a list of pre-selected amounts. In another embodiment, the stakes of the bet may be non-monetary (i.e., drinks, lunch, performing a task, etc.). The user may select the non-monetary stakes from a pre-selected list or may manually type in a proposal for the stakes.

The bet creation module 130 may allow the user to determine a method of picking a winner or loser of a bet. In some embodiments, the bet may be a competition to be decided by the performance of the users or of a third party (e.g., a sporting event). In some embodiments, a user may select a third party not associated with the bet to declare the winner of the bet between two parties. For example, one or more third parties may vote for or select one or more users, with one or more winners and losers being determined based on the result of the vote.

After receiving all information relevant to the bet, the bet creation module 130 may finalize the bet for the user. The bet may then be provided to the users the bet has been proposed to by the first user as described below.

Referring further to the bet creation module 130 and the pre-selected bet database 148, in some embodiments, the pre-selected bet database 148 may be updated by the social betting system 100. For example, the social betting system 100 may track one or more events in real-time that may be used as a basis of a bet and provide a list of upcoming events to be stored in the pre-selected bet database 148. In other words, the social betting system 100 may proactively update the list of available bets that a user may choose from.

Referring again to FIG. 2, the memory 124 is shown to include a bet confirmation module 132. After creation of a bet by a user, the social betting system 100 may transmit the bet to the other users to which the first user has proposed the bet. The bet may then be accepted, declined, or countered by each of the one or more other users. The bet confirmation module 132 may transmit the bet to the other users and receive input from the other users, and may keep track of the status of the bet as the bet is accepted, declined, or countered by each user involved.

If all users to whom the bet was proposed accept the bet, then the bet confirmation module 132 may confirm to all involved users that the bet has been accepted and is “active”. If one or more users choose to provide a counter (e.g., a proposed bet that includes a change of one or more parameters of the bet), the bet may then be transmitted to the other users involved in the bet. The other users may then accept the counter, reject the counter, or provide his or her own counter. The bet confirmation module 132 may facilitate communication between the various users, allowing the users to counter the original bet a plurality of times until the bet is accepted or declined.

If one or more users choose to decline a bet, the bet confirmation module 132 may send an indication of the decline to the other users. In some embodiments, one user may decline a bet, which may invalidate the bet for all other users. In some embodiments, one user may be able to decline a bet while other users may accept the bet. The bet parameters may then be adjusted accordingly, either by the one or more other users or automatically by the social betting system 100.

Referring again to FIG. 2, the memory 124 is shown to include a user account module 134. In some embodiments, in order to create and accept bets via the social betting system 100, a user may need to sign up or register for the service. In other embodiments, a user may not have to sign up or register to create or accept bets, and the social betting system 100 may identify and track users using other user identifiers available to the social betting system 100.

In some embodiments, users may open a user account with the social betting system 100 in order to use the social betting system 100. For example, users may download an application on a mobile device and then open a user account on the application. As another example, users may access a webpage and open a user account via the webpage. Once the user has an account, he or she may be able to access the social betting system 100 in the future by logging in (e.g., providing a username and password or other credentials, either manually entered or automatically retrieved from the mobile device). The user may further change user account information via the social betting system 100 by selecting the appropriate menu option. In some embodiments, the user account may include the user's name, contact information, age (to confirm eligibility of use of the social betting system in some cases), one or more photos, a password, and a list of contact or friends (e.g., social media friends, email contacts, etc.). In various embodiments, users may provide information relating to the contacts and friends, or such information can be retrieved from other applications via the social betting system 100.

In some embodiments, users may be invited to download the social betting system and to open the user account. For example, a first user with a user account may create a bet via the social betting system 100, and select one or more second users to offer the bet. If a second user does not have a user account, the user account module 134 may send an invite to the second users (using contact information provided by the first user). The second user may then create an account before being able to accept, decline, or counter the bet.

The user account module 134 may further manage user accounts in other ways. For example, the user account module 134 may track user activity with the social betting system 100 (e.g., tracking bets that the user has previously created, accepted, won, and lost). The user account module 134 may further manage a user database 150 configured to store user account information for use by the social betting system 100.

In some embodiments, the social betting system 100 may charge a user for use of the social betting system 100. For example, the social betting system 100 may charge a fee for creating and managing a bet, or may charge a fee per bet (e.g., if the wager of a bet is monetary, the social betting system 100 may charge a portion of the wager to one or more of the users participating in the bet). In some embodiments, the social betting system 100 may not charge a user for usage of the social betting system 100.

The memory 124 is shown to include a payment module 136. Upon resolution of a bet, the one or more losers of the bet may be responsible for a payment or other activity (e.g., drinks, lunch, etc.). The payment module 136 may facilitate the payment or other activity for the lost bet. For example, a payment system 136 may be integrated into the social betting system that allows the loser(s) of a bet to transfer funds to a winner(s) of the bet. As another example, the payment module 136 may charge a user account of the one or more losers of the bet, and provide the payment to the one or more winners of the bet. As another example, the payment module 136 may receive an indication from a user involved in the bet that the loser of the bet has paid off the bet (e.g., has taken the winner of the bet out for drinks). This may include proof (e.g., receipt, video or other media, etc.) that the loser has paid off the bet. As another example, a winner in a bet may wish to remind the loser of the bet to provide payment, and the payment module may allow the winner to provide the notification to the loser. The payment module 136 may generally be configured to keep track of all such activity between the one or more winners and one or more losers of a bet to make sure that the wager associated with the bet was fulfilled. In some embodiments, the payment module 136 may be responsible for providing alerts until the payment is resolved. In some embodiments, the users themselves may be responsible for the payment and the social betting system 100 may not manage any aspect of the payment.

In some embodiments, the social betting system 100 (and payment module 136 in particular) may allow winners of the bet to interact with the losers of the bet as part of the payment. For example, winning users may “taunt” the losing users by sending a video, picture, or other media to the loser. The payment module 136 (or other module of the social betting system 100) may provide an interface or other features to allow the winning users to provide such media to the losing users. In some embodiments, the social betting system 100 may allow interactions between the users participating in the bet (and/or other users). For example, users may take videos, photos, or text to post to show the progress of the bet. The media may be posted on the interface in a “story” or “gallery”-like format. The media uploaded during the bet may also be available for display after the bet is over, for taunting the losers, praising the winners, etc. In some embodiments, the social betting system 100 may also allow interactions between users not involved in the bet. For example, other users not involved in the bet may be allowed to view the bet, view the progress of the bet, and to provide comments on the bet. The level of interaction allowed with the bet by outside users may be determined by at least one of the users involved in the bet and the social betting system 100, in various embodiments. For example, in a public bet, any user may be allowed to comment on a bet, but in a private bet, only users directly involved in the bet may be allowed to comment on the bet.

The memory 124 is shown to include an integration module 138 generally configured to integrate the social betting system 100 with other applications. In some embodiments, as described above, bets may be created that are related to an activity that relates to another mobile application. As one example, a bet may be created based on a fantasy sports matchup (e.g., a head-to-head fantasy football matchup between two users). The integration module 138 may work in conjunction with a fantasy sports application on the user device to retrieve and send information based on the matchup. For example, the matchup may be presented as a selectable option in the list of pre-selected bets for a user. As another example, the current status of the matchup may be retrieved and displayed to the user via the social betting system. The integration module 138 may be configured to handle any such interaction with other applications based on the type of bet created.

The memory 124 is shown to include a newsfeed module 140. In some embodiments, on the social betting system 100, a newsfeed may be presented to users of the social betting system. For a particular user, the newsfeed may generally include information relating to the status of one or more bets the user is involved with. The newsfeed may further include information relating to the status of one or more bets the user's friends or contacts are involved with (but not the user himself or herself). In some embodiments, the user may be able to choose which bets, types of bets, information about the bets, etc. are displayed on the newsfeed.

Referring still to FIG. 2, the memory 124 may optionally include a location module 142. The location module 142 may determine the location of a user device (and therefore the location of the user) communicating with the social betting system 100. Since some bets (e.g., on professional sporting events) may not be permitted in some areas, the location module 142 may determine the location of the user device 110 and if a particular bet is allowed in that location. For example, the social betting system 100 may only allow certain types of bets in certain locations. In some implementations, the bets allowed in certain locations may be determined based on whether the bet is legal in the location under the laws applicable to betting via the social betting system 100 in that location. The bet creation module 130 may then use information from the location module 142 to determine which bets to present as an option to the user. Further, the location module 142 may be used to determine locally relevant events to the user that may be suggested to the user in the pre-selected list of bets.

The memory 124 may optionally include a business management module 144. In some embodiments, the social betting system 100 may partner with other businesses to provide services via the social betting system 100. For example, the social betting system 100 may provide advertisements and other content from various content providers for display on the social betting application 100. As another example, the social betting system 100 may offer incentives (e.g., coupons, discounts, freebies, etc.) to users via the social betting application. The incentives may or may not be directly related to the bets. The business management module 144 may be configured to allow various businesses to provide advertisements, incentives, and other content to users via the social betting application (e.g., allowing businesses to sign up for a service on the social betting system). In some embodiments, the business management module 144 may charge the businesses for use of the social betting system 100.

In some embodiments, the business management module 144 (or another module) may be configured to provide revenue to individual users based on advertisements provided by the business management module 144. In other words, users may be compensated for allowing advertisements and other sponsored content to be provided to the users. As one example, for sponsored content (e.g., display banners, sponsored posts, etc.) provided to users involved in a bet, 25% of revenue received from a business paying to have the sponsored content displayed may be provided to the users. Further, the percentage may be increased as more people view the bet (e.g., if the bet is shared to the public, the percentage may be increased 5% for every 50,000 views). Further, the percentage may be increased (e.g., up 2.5%, up 5%) for every post made by a user that includes sponsored content, or based on new users signing up to the social betting system 100. In various embodiments, the percentages and other metrics used by the business management module 144 may vary, and the example above is provided by way of example and is not limiting. In one embodiment, as described above, a user may choose to make a bet public or private. Making a bet public may allow for the opportunity for the user to receive revenue for sponsored content, while private bets may not be eligible for sponsored content (and therefore not eligible for revenue associated with the display of sponsored content). In some embodiments, users may be able to use revenue from sponsored content towards future bets (e.g., using the money for payments related to other bets).

The memory 124 may optionally include a tournament module 146. In some embodiments, the social betting system 100 may host a tournament-style bet in which a plurality of users participate in the same bet. Various users may sign up for the tournament-style bet, and the tournament module 146 may be configured to manage user interactions within the tournament-style bet. In one embodiment, the tournament-style bet may be a single bet where the highest scoring user in the bet wins, or the highest scoring users (e.g., the top 10%) win the bet. In another embodiment, the tournament-style bet may be a knockout-style format where users go head-to-head with each other. The tournament module 146 may be configured to randomly pair up users in such an embodiment, until just one winner (or a plurality of winners) are determined.

In some embodiments, the social betting system 100 may be configured to aggregate and provide information to other services. For example, the social betting system 100 may provide user information to advertisers or other services that may be used to provide the user with more relevant content.

In some embodiments, the social betting system 100 may allow bets to be cancelled. For example, if all users involved in a bet agree to cancel a bet (either before the bet has started or mid-bet), the social betting system 100 may cancel the bet.

Referring still to FIG. 2, a bet database 152 is shown that may be configured to store information relating to bets that are created via the social betting system 100. For example, for a given bet, the following information may be stored: the users involved in the bet, a description of the bet, the stakes of the bet, a date, time, or timeframe associated with the bet, whether the bet is public or private, any comments made by one or more users about the bet (via the newsfeed), one or more Likes or other interactions with the bet (via the newsfeed), whether the bet has been shared via a social media site, and the like. The bet database 152 may be used by various modules in the memory to retrieve information to be displayed on the social betting system 100 when necessary.

In some implementations, users may submit bet ideas to the social betting system 100. An administrator (or other managing user) of the social betting system 100 may select one or more submitted bet ideas to add as a pre-selectable option (i.e., to provide the bet as part of a bet list as described above). In such an embodiment, the social betting system 100 may compensate a user for submission of the idea (e.g., in the form of a cash payment). The amount of the compensation may be based on, for example, how often the bet is played between other users, how much revenue the social betting system 100 has generated from offering the specific bet, how popular the bet is between users of the social betting system 100, etc. The ideas submitted may be in the form of a new idea for a bet, or an improvement to an existing bet (e.g. a change in parameters of the bet).

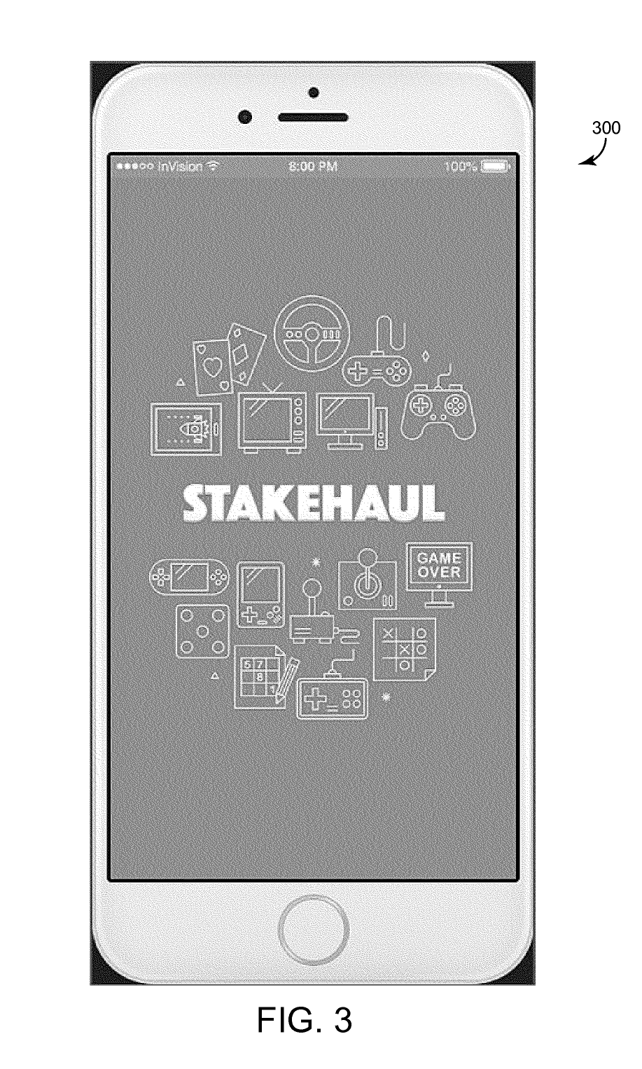

Referring now to FIGS. 3-10, various user interfaces are illustrated that describe the activities of the social betting system in greater detail. The various modules as described in the social betting system 100 may be used to generate the user interfaces of FIGS. 3-10 and to facilitate a social betting process with multiple users.

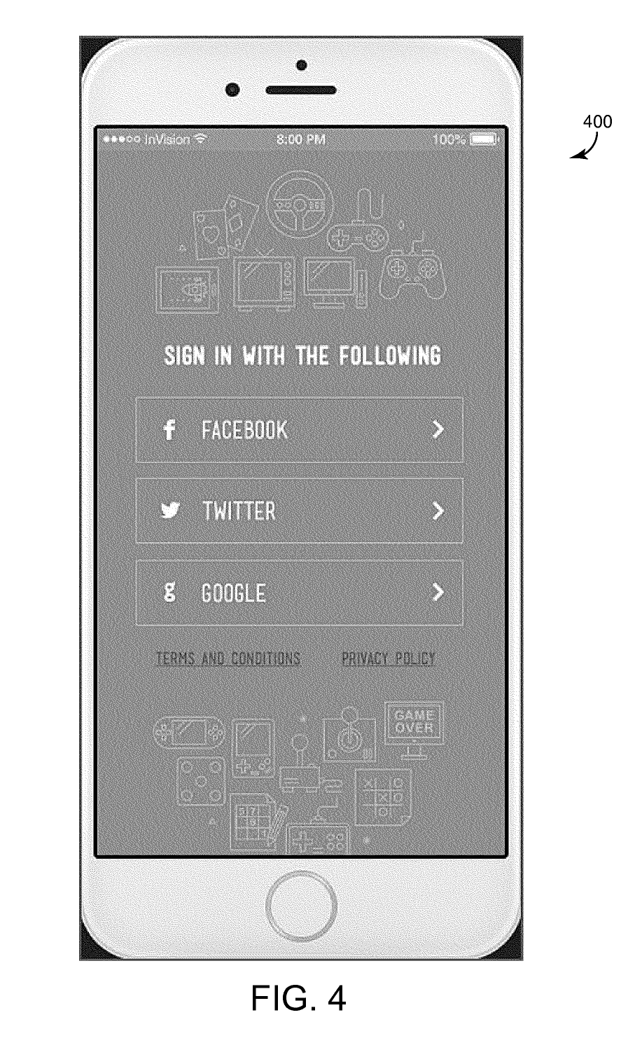

When the user first accesses or loads the social betting application, the user may be presented with a load screen such as that shown in the user interface 300 of FIG. 3. The user may then be taken to a login or signup screen as shown in the user interface 400 of FIG. 4. If the user already has an account with the social betting system, the user may enter his or her credentials (e.g., by selecting an option 402 for Facebook ID, Twitter ID, a unique ID for the social betting application, etc.) and a password. Otherwise, the user may be prompted to sign up for the social betting system.

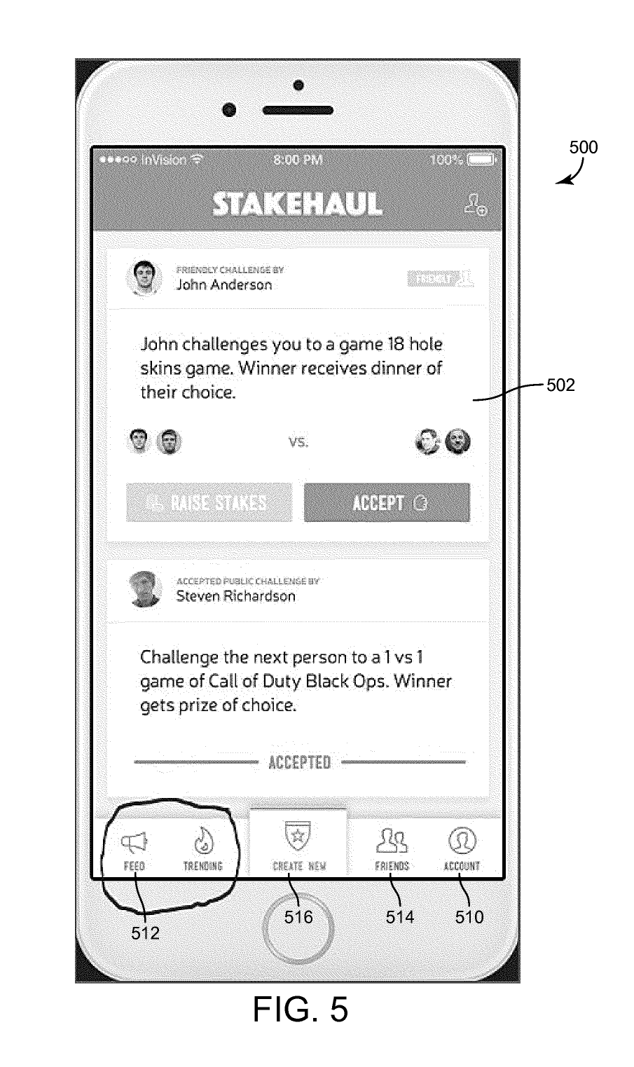

Once signed in, the user may be presented with a main screen or home screen such as that shown in the user interface 500 of FIG. 5. The main screen may act as a newsfeed 502. For example, the newsfeed 502 includes multiple entries that displays bets proposed to the user, bets that the user is currently involved with, and bets that the user's friends and contacts are currently involved with. For each bet, the newsfeed 502 may display the users involved with the bet, the bet parameters, and other relevant information. In some embodiments, the newsfeed 502 may further allow the user to share the bet on another social media platform (e.g., Facebook, Twitter, etc.) by clicking the appropriate option. Additionally, the user may be able to “Like” the bet or leave a comment about the bet. In other words, the user may interact with each individual entry (e.g., bet) in the newsfeed 502 in a similar manner compared to other entries in news feeds of other social media applications.

As shown in FIG. 5, the user interface 500 is shown to include various options at the bottom of the screen. While the options are shown on the newsfeed, such options may be displayed on any other screen on the social betting application. The options may allow the user to access account information via the social betting system (option 510), open or close a newsfeed of bets (option 512), initiate or continue a chat with another user of the social betting system, view a list of users, friends, or contacts on the social betting system (option 514), view bet history information, view a current status of a bet, review winnings or losses from bets, create a new bet (option 516), etc.

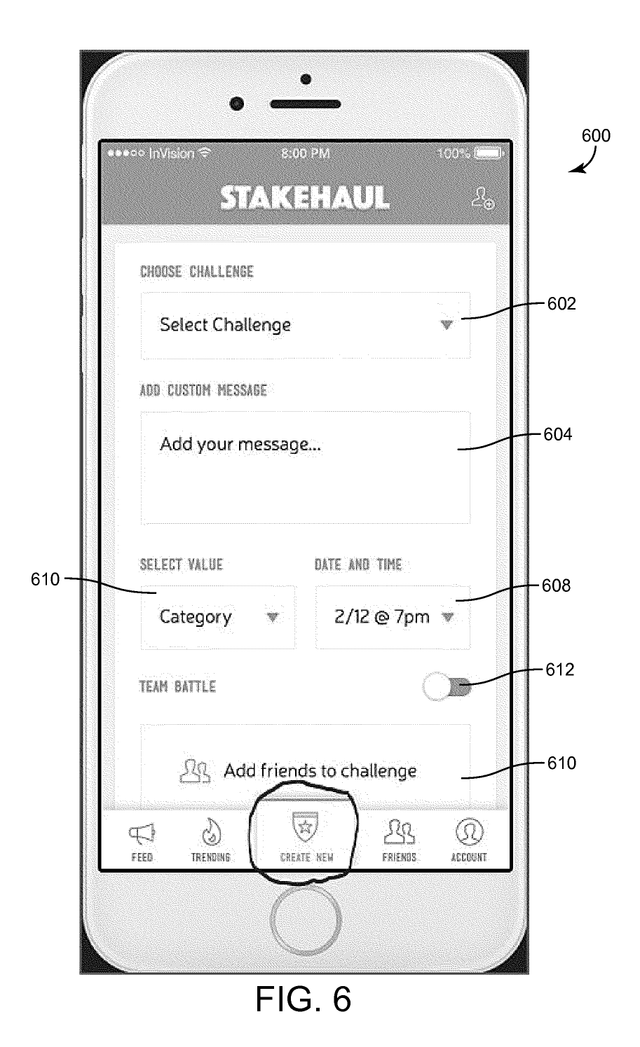

When the user wishes to create a bet via the social betting system 100, the user may be provided with the user interface 600 shown in FIG. 6. As shown, the user may to select a bet from a list of pre-selected bets (using the “Choose Challenge” drop-down menu 602). In various embodiments, the user interface 600 of FIG. 6 may further categorize bets (e.g., bets on events involving the users or not involving the users, bets on sporting events, etc.) that the user may choose from instead of just having the user choose from a large list of pre-selected bets.

In some embodiments, the social betting system 100 may prompt the user to select if the bet should be a private or public bet. If the private option is chosen, the bet is made private between the user and other participants in the bet. If the public option is chosen, the bet may be shared to non-participating users (e.g., via a newsfeed or other social media feed). In some embodiments, further options may be presented on the user interface 600 of FIG. 6 that allows the user to make the bet partially public or private (e.g., only sharing the bet with selected users, only sharing certain details of the bet, etc.).

In some embodiments, the user may adjust various parameters of the bet. For example, the user may select (or otherwise enter) a custom message for the bet in field 604. The custom message may be used to define the activity or event that the bet is based upon. The user may further select a value for the bet. As shown in FIG. 6, the user may select a value from a drop-down menu, or may enter a value at field 606. The user may choose between a monetary wager (e.g., $10, $15 or another amount) and a non-monetary wager (e.g., lunch, drinks, a task that must be performed by the losing party, or other activity). The user may further select a date and time for the bet at field 608. The deadline may be, for example, a specific date and time at which the bet will occur, or a deadline for expiration of the bet, and the like.

The user may further select one or more other participants in the bet in field 610. The participants may include a plurality of individuals, or two or more teams. For example, as shown in FIG. 6, the user may select if the bet is a team battle or not via button 612. A team battle may generally be a bet between two or more groups of people, each group including two or more people on the same side of the bet. The user, when creating the bet, may then add other users to be on his/her team and to be his/her opponents.

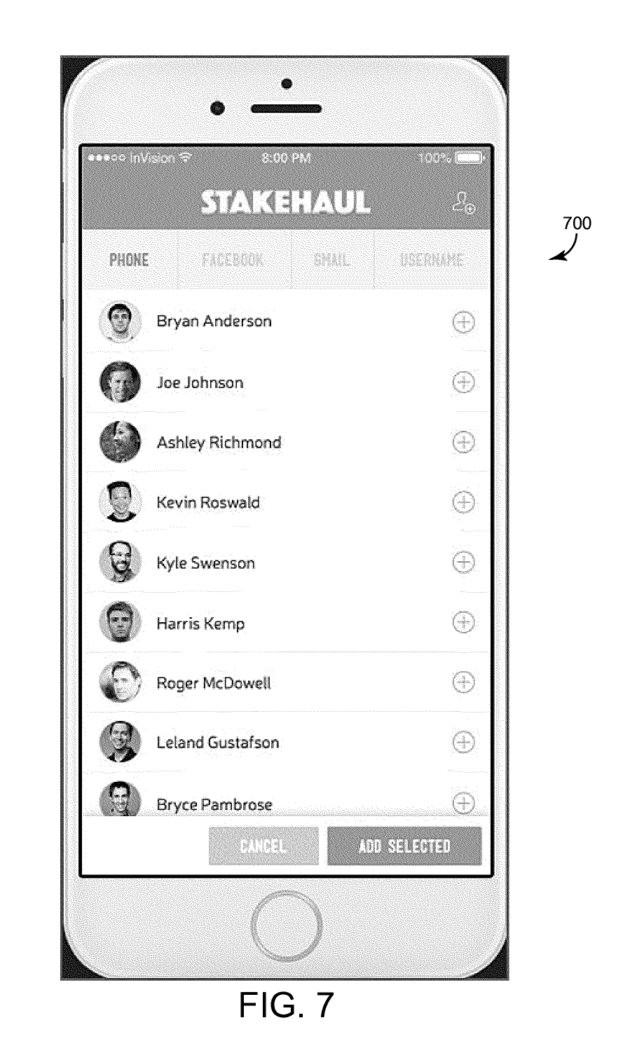

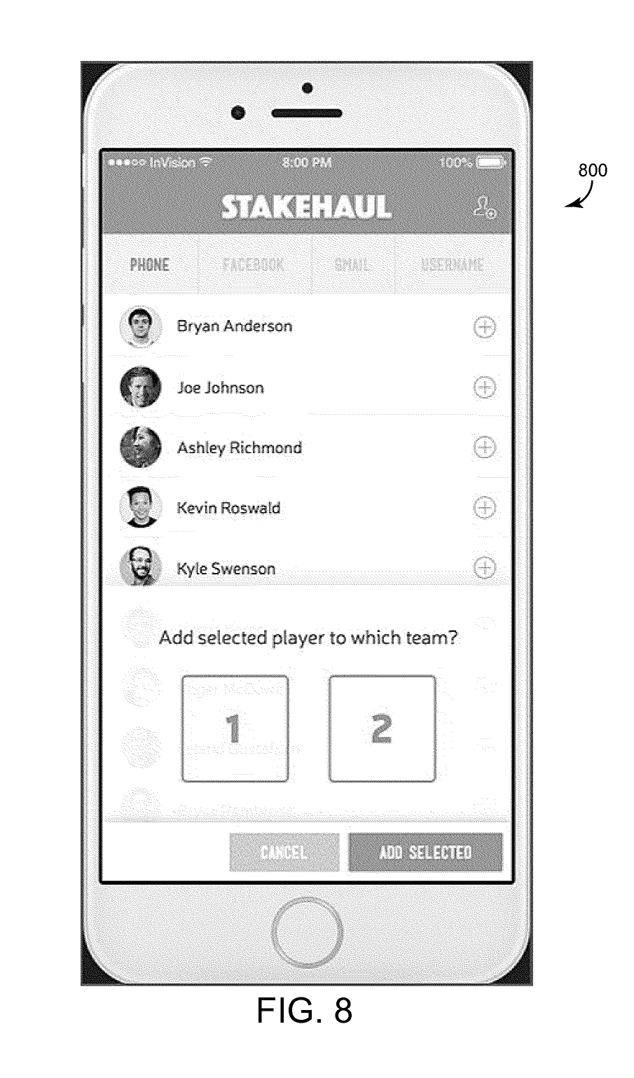

The user may add one or more friends (or other users) to the bet at a user interface 700 as shown in FIG. 7. In various embodiments, in the user interface of FIG. 7, the social betting system 100 may provide a list of phone contacts, social media friends, email contacts, etc., associated with the user, that the user can select. In some embodiments, the social betting system 100 may be configured to retrieve friends and contacts from various user accounts to present to the user. In some embodiments, the user may additionally be able to manually enter users and user contact information, and the social betting system 100 may contact the users once the bet is finalized. In some embodiments, the social betting system 100 may store a list of users associated with the user creating the bet, and may present the list in the user interface 700 of FIG. 7. If the bet is a team battle-style bet, the user may be presented with the user interface 800 of FIG. 8, which allows the user to not only add other users to the bet, but to select a team for each user.

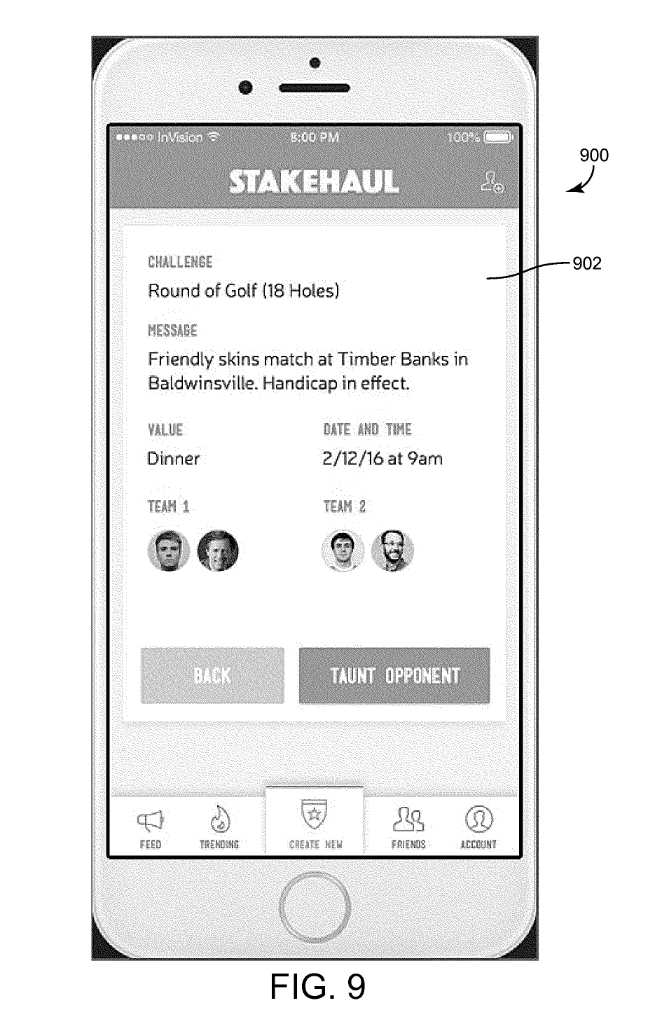

After adjusting and finalizing the parameters of the bet, the user may be presented with the user interface 900 of FIG. 9. The user interface 900 of FIG. 9 may be used by the user to review and verify the details of the bet. The user interface 900 of FIG. 9 may further include one or more options for adjusting the details of the bet, “taunting” the other users involved in the bet, and the like.

In some embodiments, the user interface 900 of FIG. 9 may be used for other bet-related activity. For example, the user may review the bet description, the wager, and the deadline for accepting the bet (in field 902). The user may further view all other users involved in the bet, along with if each user has accepted, declined, or countered (or not responded to) the bet already. In some embodiments, the user may select a Chat option that allows the user to leave a message for one or more users relating to the bet. The message may then be viewable to other users on the user interface before they respond to the bet.

If the user has just accepted a bet, the user interface 900 of FIG. 9 may include a confirmation message or screen. The confirmation screen indicates that the user has accepted the bet and provides bet details along with the status of the other users (e.g., whether other users have accepted the bet). The user interface 900 of FIG. 9 may further be capable of providing alerts when other users send a bet to the user, when other users have accepted a bet, etc.

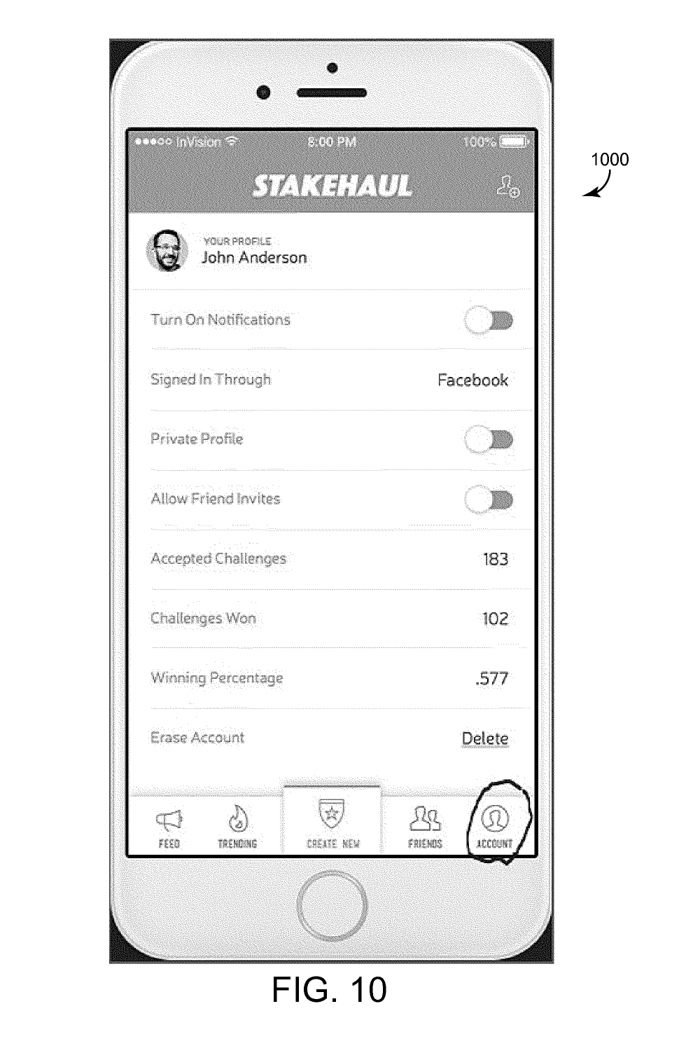

Referring to FIG. 10, a user interface 1000 is shown that may allow users to set various account settings. For example, the user may turn notifications on or off (e.g., alerts that other users are sending bets or accepting bets), one or more login preferences, whether the user profile is private or public, whether to allow other users to propose a bet to the user, etc. The user may view various statistics relating to active and completed bets.

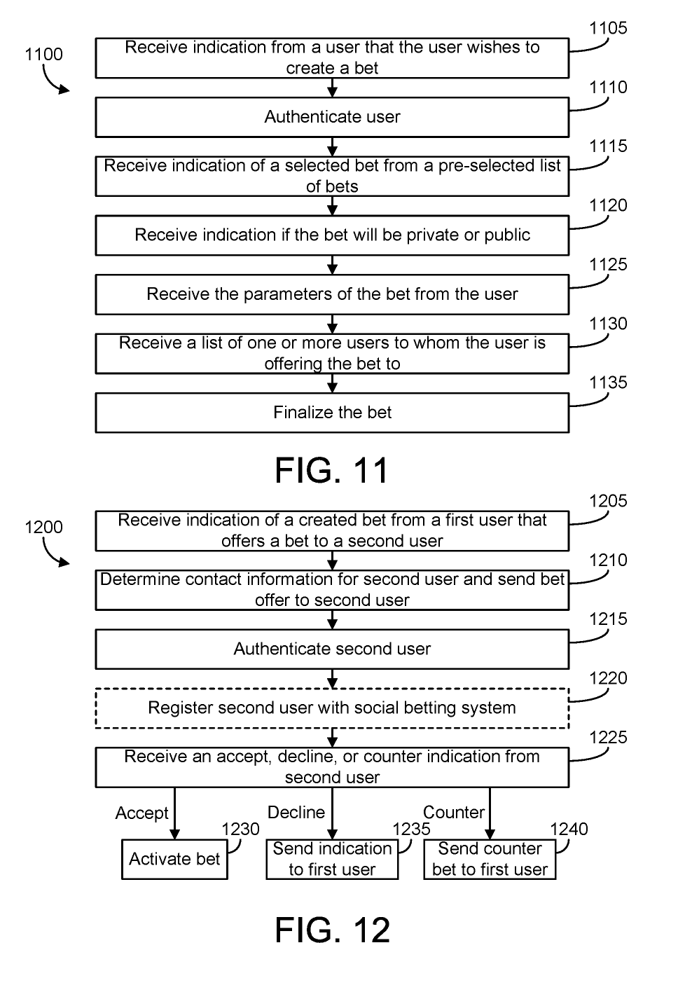

Referring now to FIG. 11, a flow chart of a process 1100 for creating a bet via the social betting system is shown. The process 1100 begins when the social betting system receives an indication from the user that the user wishes to create a bet (block 1105). The process further includes authenticating the user, in some embodiments (e.g., receiving login credentials such as a username and password) (block 1110). The authenticating step may occur before receiving the indication from the user to create a new bet, in some embodiments.

The process 1100 further includes receiving an indication of a bet selected from a pre-selected list of bets, in some embodiments (block 1115). The process 1100 also includes receiving an indication if the user wishes to make the bet private or public, in some embodiments (block 1120). The steps of receiving the indications from the user may include presenting a user interface to the user on a social betting system that allows the user to choose from a pre-selected list of bets and between a private bet or a public bet.

The process 1100 further includes receiving parameters of the bet from the user (block 1125). The social betting system may present a user interface allowing the user to specify the parameters of the bet. For example, the user may select a bet from a pre-selected list of bets or provide a custom message associated with the selected bet. Further, the user may select the wager (e.g., a monetary or non-monetary wager). Further, the user may set a deadline for the bet (e.g., a date by which the bet must be accepted).

The process 1100 further includes receiving a list of one or more users to whom the user is offering the bet (block 1130). The social betting system may present a list of users associated with the user creating the bet, and the user may select one or more of the users from the list. In another example, the user may provide one or more users not on a list to the social betting system for proposing the bet towards. The process 1100 further includes finalizing the bet when the user is finished adjusting the parameters of the bet (block 1135).

Referring to FIG. 12, a flow chart of a process 1200 for confirming a bet with a user via the social betting system is shown. The process 1200 begins after the creation of a bet by a first user that offers a bet to a second user. The process 1200 includes receiving an indication of the created bet from the first user that offers the bet to the second user (block 1205). The process 1200 includes determining contact information for the second user and sending the bet offer to the second user (block 1210). The process 1200 may further include authenticating the one or more second users (block 1215). For example, if the users do not have accounts with the social betting system, the process 1200 may optionally include registering the users with the social betting system (if the user opts to) (block 1220). As another example, authenticating the users may include receiving login credentials such as a username and password for each user.

The process 1200 further includes receiving an accept, decline, or counter indication from a second user (block 1225). If the second user accepts the bet, then the bet may be “active” and an alert may be provided to each user involved in the bet indicating as such (block 1230). If the second user declines the bet, an indication may be provided to the first user (block 1235).

If the second user counters the bet, the counter bet may be sent back to the first user (block 1240). The first user may then have the option to accept, decline, or counter the counter bet. The first and second user may then continue to go back and forth (i.e., countering each other's bet) until the bet is finally accepted or declined.

The process of FIG. 12 may be adapted if the first user wishes to offer the bet to more than one second users (e.g., three or more total users must be involved in the bet, or the same bet offered to multiple other users). For example, if one user declines a bet but another user accepts a bet, the bet may either be activated or nullified based on the type of bet and the preferences of the users. The process of FIG. 12 may be adapted to handle a series of counter offers, declines of bets, and acceptances of bets that allow the plurality of users to determine an acceptable bet and bet parameters.

In various embodiments, the processes 1100 and/or 1200, and/or any of the systems and methods discussed in the present disclosure, may include processing received types of wagers and/or parameters of wagers using a rules engine to determine compliance with one or more predetermined rules. The rules engine may be implemented in the client devices and/or the server. In some embodiments, the rules engine determines the rules for determining compliance based at least in part on a geographic location of the user device. For example, the rules engine may store a set of rules for each of several geographic regions (e.g., cities, states, countries, etc.) and may select the rule set for the determined geographic region of the user device. In some such implementations, the rules set may be based on local laws/ordinances that relate to the legality or permissibility of such wagers. In various embodiments, the system may determine the location using a location determination circuit of the user device (e.g., a cellular transceiver or Global Positioning System (GPS) device), using input from the user, or in some other manner. In such implementations, the system may allow for the application to be used seamlessly on mobile devices as the users travel between locations while helping ensure any wagers made using the application are in compliance with local laws or other applicable rules. In some embodiments, the rules may be based on factors other than laws/ordinances, such as rules established by the system or one or more of the users participating in the wager (e.g., enabling/disabling wagers based on third party events, enabling/disabling monetary wagers or wagers for items of value, enabling/disabling custom wagers created by users, etc.).

Referring generally to the figures, one implementation of the systems and methods herein may allow users to bet on particular outcomes in events, such as sporting events. The systems and methods herein may allow users to wager on performances of multiple participants in the sporting events. For example, users may bet on which player in a sporting event amasses more points or other statistics (e.g., most points in a basketball game, more yards in a football game), which player achieves a benchmark first (e.g., first to ten points, first to three strikeouts), which players outperform other players (e.g., specific player vs. player statistical comparisons), etc. As another example, users may bet on if a player achieves a certain benchmark based on a threshold set by the social betting system (e.g., if a player scores more than 10 points, 20 points, etc.). In other words, users may be able to bet on player vs. player matchups, or on player vs. “house” matchups (wherein the house is the entity setting a threshold value). In other embodiments, such principles as described herein may be applicable to non-sporting events (e.g., award shows, political debates, etc.).

In some implementations, bets may include a “handicap”, odds, betting line, or another representation of talent or value of competing entities in a bet. For example, in a golf bet, one player might be more skilled than a second player, and a handicap may be specified as part of the bet parameters to help make the bet more fair to all participants. As another example, in a bet on a sporting event, it may be determined that one team has to win by a certain amount of points in order for that team to be a winner in the bet (e.g., “cover the spread”); otherwise the team that lost the game may still be deemed a winner in the context of the bet. As yet another example, in a competition where a first side is more likely to win than a second side, there may be no handicap or spread set for the competition, but the payout or compensation for the bet may be larger for the user who has bet on the second side compared to the first side (e.g., betting on the first side who is a favorite against the second side at 3 to 1 odds may result in a payout of $X dollars for a user who bet on the first side and $3X for a user who bet on the second side. In some embodiments, such a parameter can be set automatically by the social betting system based on available information about the bet. In some embodiments, one or more users in the bet can create or modify such parameters, allowing the users to customize the exact stakes in the bet. For example, a user may increase the number of strokes he or she is receiving in a golf match, increase or decrease the spread in a game, etc. The social betting system may assist the users in creating or modifying the parameters (e.g., suggesting when a spread for a sporting event deviates significantly from what is generally expected by the social betting system) and may provide a suggestion to the users if a bet, with the given parameters, is a good bet or bad bet.

Referring generally to the figures and the following description, an implementation of the systems and methods herein will be described with reference to betting that can occur based on a fantasy sports matchup game. This implementation will be described with reference to a fantasy football game (both one-day fantasy football and season-long fantasy football); however, this implementation is not limiting and is only provided as an example, and the features described herein may be implemented for other bets or games by the social betting system.

In one embodiment, a first user may propose a bet to a second user (or more than one second user) regarding a one-day fantasy football competition. The first user may provide a description of the bet by selecting (or entering) a format for the bet. For example, for a fantasy football-related bet, the format may include a lineup specifying how many players at each position (e.g., quarterback, running back, etc.) should be chosen for the lineup, and a scoring system for the matchup. The first user may further provide the wager (money or another prize) and a deadline or timeframe (e.g., the matchup takes place over one weekend's worth of games, one day's worth of games, etc.) for the bet. After the bet is accepted, each user may select his or her lineup of players to represent his or her team in the one-day fantasy football competition (or, the users may specify the lineup as part of the acceptance or verification of the bet).

As described above, the format chosen by the first user (and/or by the second user, if the second user counter offers the first user) may include the starting positions in each user's lineup. For example, the lineups may include one quarterback, two running backs, two wide receivers, one tight end, one kicker, and one flex position. Any number of players at any position may be specified for the starting lineup, in other embodiments. In another embodiment, the users may choose to play a “default” format where the social betting system specifies the starting positions.

Some bets may require a user input (e.g., a user setting a lineup) as a prerequisite for participating in the bet. In some embodiments, the social betting system may allow users, while a bet is going on, to change his or her mind regarding one of the inputs. Such a change may be based on the format of the game that was chosen for the bet. For example, for the one-day fantasy football example, the change may be a change in the user's starting lineup. Users may change players in their lineup so long as the player being taken out of the lineup and the player being put into the lineup have not begun playing.

As another example format for the one-day fantasy football example, users may swap out a first player for a second player even if the first player has begun or finished playing. In such a format, the user making the swap can keep all points gained by the first player while the first player was in his or her lineup, but will not gain points scored thereafter by the first player (while the points for the second player begin counting for the player once the substitution is made, but points scored by the second player before the substitution do not count). In one embodiment, this could allow the user to have a “first half” player and a “second half” player where each player is active for one half (if the player plays in an overtime game, the points can count towards the “second half” player only). The game could make swapping players optional, and may or may not restrict the player pool the user may choose from.

As another example format for the one-day fantasy football example, instead of choosing players to play for a full game, users may choose players to play for his or her team for only one half. For example, assume a format where a user's lineup has ten positions (two quarterbacks, two running backs, two wide receivers, two tight ends, and two kickers). The user may select two quarterbacks, but also must select which a half of a game for each quarterback (first half or second half). Then, only the points earned by the quarterback during the specified half count towards the team total. The social betting system may allow the user to make changes to his or her lineup as long as the players involved in the change have not begun playing (e.g., five minutes before their game is scheduled to start).

As another example format for the one-day fantasy football example, instead of allowing all users involved in a bet to choose the same players, the social betting system may “host” a draft between the users. Each user involved in the bet may take turns drafting eligible players to their team. The social betting system may send alerts every time a user's position in the draft is up, prompting the user to select his or her next player for his or her team. The social betting system may continue to prompt the users until each team is filled and all parameters of the bet are satisfied (e.g., all lineups selected by each user are legal and completed before the games begin). The draft format may be a snake format (where each user takes turns selecting players based on a predetermined order) or an auction format (where each user bids on players to select for his or her team). Further, a draft order may be defined using any type of parameter (e.g., best-performing or worst-performing users receive the first selection, etc.).

As another example related to the idea of hosting a draft between users, a draft may be held for a bet that lasts more than one day or one week. For example, for a season-long fantasy football example, each user in the bet may draft a new team every two weeks, every three weeks, etc. Further, each user may be able to specify a number of “keepers” (e.g., players that the user can keep on his or her team instead of allowing the player to be drafted by another team in an upcoming draft). The number of keepers allowed and the time and date of each new draft may be specified via the bet parameters, by the users or by the social betting system.

As another example format for the one-day fantasy football example, the social betting system may have a format where each user must select one player from every game to take place over a week (or weekend, or day). Each user involved in the bet may select the one player from each game, and the highest scoring team wins. In various embodiments, the social betting system may further restrict the lineup that each user can create. For example, the user may have to select one player from each game, but also must select, e.g., at least two quarterbacks, two running backs, two wide receivers, and two kickers.

Referring to the various one-day fantasy football examples described above, the features discussed may be applied to other types of bets. For example, some bets may allow a user to edit his or her lineup or other options for a bet before the bet begins (e.g., if the bet is related to one or more predictions for an event, the user may change his or her selections for what happens in the event). Such changes may be made either before the event or during the event. In general, the social betting system may allow for such dynamic bets where users can compete with one another, making changes and adjustments while the bet is active.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, orientations, etc.). By way of example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on memory or other machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products or memory including machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, by way of example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. cm What is claimed is:

1. A system, comprising:
at least one computing device operably coupled to at least one memory and configured to:
receive, from an application on a first device, a first set of data packets indicating a proposed wager and one or more parameters of the wager;
process, using a rules engine, the first set of data packets to determine conformance of the proposed wager and the one or more parameters of the wager to a set of predetermined rules;
in response to determining the proposed wager and the one or more parameters conform to the rules, transmit, to the application on a second device, a second set of data packets indicating the proposed wager and the one or more parameters of the wager;
receive, from the second device, a third set of data packets indicating a response to the proposed wager and the one or more parameters of the wager;
finalize the wager and the one or more parameters of the wager in response to determining the response indicates an approval;
determine an outcome of the wager; and
transmit, to the application on the first device and the second device, a fourth set of data packets indicating a resolution of the wager.

2. The system of claim 1, wherein the at least one computing device is configured to:
generate a list of pre-approved wagers and one or more parameters for each wager; and
transmit, to the first device, the list of pre-approved wagers and one or more parameters for each wager;
wherein receiving the first set of data packets comprises receiving a selection of a pre-approved wager and one or more values representative of one or more parameters of the wager.

3. The system of claim 1, wherein the at least one computing device is configured to:
analyze the first set of data packets to determine the type of wager;
determine whether the user has permission to participate in the type of wager;
approve the wager in response to determining the user has permission; and
set the one or more parameters for the wager.

4. The system of claim 1, wherein the at least one computing device is configured to:
analyze the first set of data packets to determine the wager relates to a contest hosted by a third party;
access information from the third party; and
determine at least one of the one or more parameters of the wager or the outcome of the wager from the accessed information.

5. The system of claim 4, wherein accessing information from the third party comprises receiving an additional set of data packets from the first device comprising information from the application relating to the contest.

6. The system of claim 1, wherein the wager is based on the outcome of a third party event;
wherein the at least one computing device is further configured to automatically determine the outcome of the wager using information about the third party event obtained from a source other than the first device and the second device.

7. The system of claim 1, wherein the wager is based on the outcome of an event occurring involving at least one of a first user of the first device and a second user of the second device;
wherein the at least one computing device is further configured to receive the outcome of the wager from one of the first device and second device.

8. The system of claim 1, wherein finalizing the wager and the one or more parameters of the wager comprises:
receiving a modification of one or more parameters of the proposed wager from the second device;
transmitting the modification of the one or more parameters of the proposed wager to the first device;
receiving one of a modification of the one or more parameters of the proposed wager or an approval of the one or more parameters of the wager; and
continuing to transmit modified parameters of the proposed wager to both the first device and second device, and receive a modification of the one or more parameters, until an approval of the one or more parameters of the wager is received from both the first device and second device.

9. The system of claim 1, wherein the one or more parameters of the wager comprise at least one of:
a date or time when the wager will occur;
a duration of the wager;
a deadline for the wager when the event associated with the wager is scheduled to end;
one or more threshold values that indicates a winning event or losing event associated with the wager;
a location of where the wager will occur;
one or more user credentials of one or more users involved in the wager; and
compensation to be provided to one or more users upon the completion of the wager.

10. The system of claim 1, wherein the at least one computing device is further configured to:
receive approval from the first device and second device to allow the wager to be presented within a social media interface within the application on other devices, the other devices associated with users connected to a user of at least one of the first device or the second device through the application;
wherein the social media interface is configured to display a status of the wager and the one or more parameters of the wager.

11. A method, comprising:
receiving, at a server from an application on a first device, a first set of data packets indicating a proposed wager and one or more parameters of the wager;
processing, using a rules engine, the first set of data packets to determine conformance of the proposed wager and the one or more parameters of the wager to a set of predetermined rules; in response to determining the proposed wager and the one or more parameters conform to the rules, transmitting, by the server to the application on a second device, a second set of data packets indicating the proposed wager and the one or more parameters of the wager;
receiving, at the server from the second device, a third set of data packets indicating a response to the proposed wager and the one or more parameters of the wager;
finalizing, at the server, the wager and the one or more parameters of the wager in response to determining the response indicates an approval;
determining, at the server, an outcome of the wager; and
transmitting, by the server to the application on the first device and the second device, a fourth set of data packets indicating a resolution of the wager.

12. The method of claim 11, wherein the first set of data packets comprise information relating to at least one of:
a selection of a wager and one or more values representative of one or more parameters of the wager from a list of pre-approved wagers;
an indication of if the wager is to be made private to the users involved in the wager;
one or more user credentials to be verified at the server; and
an identification of one or more participants in the wager.

13. The method of claim 11, further comprising:
analyzing the first set of data packets to determine the type of wager;
determining whether the user has permission to participate in the type of wager;
approving the wager in response to determining the user has permission; and
setting the one or more parameters for the wager.

14. The method of claim 11, wherein finalizing the wager and the one or more parameters of the wager comprises:
receiving a modification of one or more parameters of the proposed wager from the second device;
transmitting the modification of the one or more parameters of the proposed wager to the first device;
receiving one of a modification of the one or more parameters of the proposed wager or an approval of the one or more parameters of the wager; and
continuing to transmit modified parameters of the proposed wager to both the first device and second device, and receive a modification of the one or more parameters, until an approval of the one or more parameters of the wager is received from both the first device and second device.

15. The method of claim 11, wherein the one or more parameters of the wager comprise at least one of:
a date or time when the wager will occur;
a duration of the wager;
a deadline for the wager when the event associated with the wager is scheduled to end;
one or more threshold values that indicates a winning event or losing event associated with the wager;
a location of where the wager will occur;
one or more user credentials of one or more users involved in the wager; and
compensation to be provided to one or more users upon the completion of the wager.

16. The method of claim 11, further comprising:
receiving approval from the first device and second device to allow the wager to be presented within a social media interface within the application on other devices, the other devices associated with users connected to a user of at least one of the first device or the second device through the application;
wherein the social media interface is configured to display a status of the wager and the one or more parameters of the wager.

17. A social wagering system, comprising:
a plurality of user devices, each user device including a social wagering application; and
a server configured to manage a plurality of wagers of one or more users of the user devices, the server comprising a processor and a memory having instructions stored thereon that, when executed by the processor, cause the processor to:
receive a first set of data packets from a first device indicating a proposed wager and one or more parameters of the wager, and to determine conformance of the proposed wager and the one or more parameters of the wager to a set of predetermined rules;
transmit a second set of data packets indicating the proposed wager and the one or more parameters of the wager to a second user device, receive a third set of data packets indicating a response to the proposed wager and the one or more parameters of the wager, and finalize the wager; and
determine an outcome of the wager and transmit a resolution of the wager to the application on the first device and second device.

18. The social wagering system of claim 17, further comprising establishing the wager by:
generating a list of pre-approved wagers and one or more parameters for each wager;
transmitting, to the first device, the list of pre-approved wagers and one or more parameters for each wager; and
receiving a selection of a pre-approved wager and one or more values representative of one or more parameters of the wager.

19. The social wagering system of claim 17, further comprising establishing the wager by:
analyzing the first set of data packets to determine the type of wager;
determining whether the user of the first device has permission to participate in the type of wager;
approving the wager in response to determining the user has permission; and
setting the one or more parameters for the wager.

20. The social wagering system of claim 17, further comprising finalizing the wager by:
receiving a modification of one or more parameters of the proposed wager from the second user device;
transmitting the modification of the one or more parameters of the proposed wager to the first user device;
receiving one of a modification of the one or more parameters of the proposed wager or an approval of the one or more parameters of the wager; and
continuing to transmit modified parameters of the proposed wager to both the first user device and second user device, and receive a modification of the one or more parameters, until an approval of the one or more parameters of the wager is received from both the first device and second device.
